(19) United States
(12) Patent Application Publication
(10) Pub. No.: US 2017/0288231 A1
(43) Pub. Date: Oct. 5, 2017

(54) METHOD FOR MANUFACTURING OF SLURRY FOR NEGATIVE ELECTRODE

(71) Applicant: LG Chem, Ltd., Seoul (KR)

(72) Inventors: Ji Hee Yoon, Daejeon (KR); Jun Soo Park, Daejeon (KR); Je Young Kim, Daejeon (KR); Jung Woo Yoo, Daejeon (KR)

(73) Assignee: LG Chem, Ltd., Seoul (KR)

(21) Appl. No.: 15/470,201

(22) Filed: Mar. 27, 2017

(30) Foreign Application Priority Data
Mar. 29, 2016 (KR) 10-2016-0037489

(51) Int. Cl. H01M 4/62; H01M 4/36; H01M 4/04; H01M 4/587; H01M 4/1393; H01M 4/133; H01M 4/48

(52) U.S. Cl. CPC H01M 4/622; H01M 4/133; H01M 4/364; H01M 4/483; H01M 4/587; H01M 4/1393; H01M 4/0404; H01M 4/0435; H01M 10/0525

(57) ABSTRACT

The present invention relates to a method of preparing a negative electrode slurry, and, specifically, the present invention provides a method of preparing a negative electrode slurry which includes the steps of preparing a first negative electrode slurry including a silicon-based active material, a carboxymethyl cellulose, and a styrene-butadiene rubber, and a second negative electrode slurry including a graphite-based active material, a conductive agent, a styrene-butadiene rubber, and a carboxymethyl cellulose (step 1), and mixing the first negative electrode slurry and the second negative electrode slurry which are prepared in step 1 (step 2).

### CROSS-REFERENCE TO RELATED APPLICATIONS

This application claims the benefit of Korean Patent Application No. 10-2016-0037489, filed on Mar. 29, 2016, in the Korean Intellectual Property Office, the disclosure of which is incorporated herein in its entirety by reference.

### TECHNICAL FIELD

The present invention relates to a negative electrode active material and a secondary battery including the same.

### BACKGROUND ART

Requirements for the use of alternative energy or clean energy have increased due to the rapid increase in the use of fossil fuels, and, as a part of this trend, power generation and electricity storage using an electrochemical reaction are the most actively researched areas.

Currently, a typical example of an electrochemical device using the electrochemical energy may be a secondary battery and there is a trend that its usage area is expanding more and more. In recent years, demand for secondary batteries as an energy source has been significantly increased as technology development and demand with respect to portable devices, such as portable computers, mobile phones, and cameras, have increased. Among these secondary batteries, lithium secondary batteries having high energy density, high operating potential, long cycle life, and low self-discharging rate have been subjected to considerable research and have been commercialized and widely used.

In line with the increased need for high-capacity and high-power lithium ion batteries, research using silicon, which has a theoretical capacity 10 times higher than that of graphite that has been conventionally used as a negative electrode, has been actively conducted.

However, with respect to the silicon, cracks may occur due to high volume expansion occurred during charge and discharge, and, accordingly, a binding force between silicon particles or between the silicon particle and a binder may be reduced. Eventually, life characteristics of the lithium secondary battery may be degraded due to the above limitation.

Thus, in a secondary battery using silicon particles as a negative electrode active material, there is a need to develop a method which may suppress volume expansion of the silicon particles even during charge and discharge of the secondary battery.

[Prior Art Document] Japanese Patent Application Laid-open Publication No. 2005-327642

### DISCLOSURE OF THE INVENTION

### Technical Problem

An aspect of the present invention provides a method of preparing a negative electrode slurry for the preparation of a negative electrode having improved life characteristics.

### Technical Solution

According to an aspect of the present invention, there is provided a method of preparing a negative electrode slurry which includes the steps of: preparing a first negative electrode slurry including a silicon-based active material, a carboxymethyl cellulose, and a styrene-butadiene rubber, and a second negative electrode slurry including a graphite-based active material, a conductive agent, a styrene-butadiene rubber, and a carboxymethyl cellulose (step 1); and mixing the first negative electrode slurry and the second negative electrode slurry which are prepared in step 1 (step 2).

### Advantageous Effects

According to a method of preparing a negative electrode slurry of the present invention, since a styrene-butadiene rubber is added with a carboxymethyl cellulose at an initial stage of slurry preparation, probability of distribution of the styrene-butadiene rubber on a surface of a silicon-based active material is increased. Thus, since the number of effective contact surfaces between the silicon-based active material and the styrene-butadiene rubber is increased, a severe volume change of the silicon-based active material may be suppressed and extraction of the silicon-based active material from an electrode may be prevented. As a result, a negative electrode having improved life characteristics may be prepared.

### BRIEF DESCRIPTION OF THE DRAWINGS

The following drawings attached to the specification illustrate preferred examples of the present invention by example, and serve to enable technical concepts of the present invention to be further understood together with detailed description of the invention given below, and therefore the present invention should not be interpreted only with matters in such drawings.

FIG. 1 is a schematic view illustrating a silicon-based active material, a graphite-based active material, and a styrene-butadiene rubber which are present in a negative electrode prepared according to an embodiment of the present invention; and

FIG. 2 is a graph illustrating characteristics of an example of the present invention and a comparative example.

### MODE FOR CARRYING OUT THE INVENTION

Hereinafter, the present invention will be described in more detail to allow for a clearer understanding of the present invention.

It will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention.

The terminology used herein is for the purpose of describing particular example embodiments only and is not intended to be limiting of the present invention. In the specification, the terms of a singular form may include plural forms unless referred to the contrary.

It will be further understood that the terms “include,” “comprise,” or “have” when used in this specification, specify the presence of stated features, numbers, steps, elements, or combinations thereof, but do not preclude the presence or addition of one or more other features, numbers, steps, elements, or combinations thereof.

A method of preparing a negative electrode slurry according to an embodiment of the present invention includes the steps of: preparing a first negative electrode slurry including a silicon-based active material, a carboxymethyl cellulose, and a styrene-butadiene rubber, and a second negative electrode slurry including a graphite-based active material, a conductive agent, a styrene-butadiene rubber, and a carboxymethyl cellulose (step 1); and mixing the first negative electrode slurry and the second negative electrode slurry which are prepared in step 1 (step 2).

Hereinafter, the method of preparing a negative electrode slurry according to the present invention will be described in detail for each step.

In the method of preparing a negative electrode slurry according to the present invention, step 1 is a step of preparing a first negative electrode slurry including a silicon-based active material, a carboxymethyl cellulose, and a styrene-butadiene rubber, and a second negative electrode slurry including a graphite-based active material, a conductive agent, a styrene-butadiene rubber, and a carboxymethyl cellulose.

The first negative electrode slurry according to an embodiment of the present invention may include a silicon-based active material.

As the silicon-based active material, at least one selected from the group consisting of silicon (Si), SiO. (0<x<2), a Si—C composite, and a Si—Y alloy (herein, Y is an element selected from the group consisting of alkali metals, alkaline earth metals, transition metals, group 13 elements, group 14 elements, rare earth elements, and a combination thereof) may be used. In this case, the Si may be crystalline or amorphous.

In a case in which the silicon-based active material is used, a binding force between a surface of the partially oxidized silicon-based active material and the carboxymethyl cellulose or the styrene-butadiene rubber and a carboxyl group is further increased so that degradation of an electrode may be suppressed.

An average particle diameter (D50 of the silicon-based active material may be in a range of 0.1 μm to 10 μm. In a case in which the average particle diameter of the silicon-based active material is greater than 10 μm, since volume expansion of the silicon-based active material occurred during charge and discharge of a battery excessively occurs, adhesion between active material particles may be reduced.

In the present invention, the average particle diameter of the particles may be defined as a particle diameter at 50% in a cumulative particle diameter distribution. For example, the average particle diameter (D50 of the particles according to an embodiment of the present invention may be measured by using a laser diffraction method. The laser diffraction method may generally measure a particle diameter ranging from a submicron level to a few mm, and may obtain highly repeatable and high resolution results.

The first negative electrode slurry according to the embodiment of the present invention may include a carboxymethyl cellulose (CMC). The carboxymethyl cellulose may be included as a thickener, and the thickener may improve coating properties and fluidity of the negative electrode slurry including the first negative electrode slurry.

The first negative electrode slurry according to the embodiment of the present invention may include a styrene-butadiene rubber (SBR). The styrene-butadiene rubber may be included as a binder and may provide adhesion between a current collector and the negative electrode active material or between the negative electrode active material particles. The binder may not only be composed of the styrene-butadiene rubber, but may also further include an acryl-based binder, acrylic acid, acrylonitrile, and an isoprene polymer in addition to the styrene-butadiene rubber. During the preparation of the first negative electrode slurry, the above materials may be added as binder materials in addition to the styrene-butadiene rubber.

The silicon-based active material, the carboxymethyl cellulose, and the styrene-butadiene rubber in the first negative electrode slurry according to the embodiment of the present invention may be included in a weight ratio of 94:3.0:3.0 to 99:0.5:0.5.

In a case in which, in the above weight ratio, an amount of the styrene-butadiene rubber is greater than 3.0 parts by weight and an amount of the carboxymethyl cellulose is greater than 3.0 parts by weight, resistance in the electrode may be increased due to excessive amounts of the binder and the thickener. In a case in which the styrene-butadiene rubber is included in an amount less than 0.5 part by weight, since sufficient adhesion is not provided to the silicon-based active material, the silicon-based active material may be extracted from the electrode or life characteristics may be degraded. In a case in which the carboxymethyl cellulose is included in an amount less than 0.5 part by weight, a solid content in the first negative electrode slurry may not be properly dispersed.

In the method of preparing a negative electrode slurry according to the embodiment of the present invention, a method of preparing the first negative electrode slurry may include the steps of: preparing a first mixed solution by mixing a carboxymethyl cellulose and a styrene-butadiene rubber with a solvent (step 1a); and mixing the first mixed solution with a silicon-based active material to prepare a first negative electrode slurry (step 1b).

Hereinafter, the method of preparing the first negative electrode slurry according to the present invention will be described in detail for each step.

In the method of preparing the first negative electrode slurry according to the present invention, step 1a is a step of preparing a first mixed solution by mixing a carboxymethyl cellulose and a styrene-butadiene rubber with a solvent.

Since a conventional method of preparing a negative electrode slurry proceeds in sequence of adding a styrene-butadiene rubber after a carboxymethyl cellulose, a conductive agent, and an active material are first mixed, probability of first distribution of the carboxymethyl cellulose, as a thickener, on a surface of the active material is high.

However, in the present invention, since the styrene-butadiene rubber is first mixed with the carboxymethyl cellulose and the active material is then added, probability of distribution of the styrene-butadiene rubber on a surface of the silicon-based active material is increased.

Thus, the number of effective contact surfaces between the silicon-based active material and the styrene-butadiene rubber is increased, and the styrene-butadiene rubber, as a binder, may play a role in better supporting the silicon-based active material. Accordingly, a severe volume change of the silicon-based active material may be suppressed even during the charge and discharge, and the extraction of the silicon-based active material from the electrode may be prevented due to strong adhesion.

Water may be used as the solvent. In a case in which a conventional binder, such as polyvinylidene fluoride (PVDF), is used, a non-aqueous system is mainly used in which the polyvinylidene fluoride is dissolved in an organic solvent such as N-methyl-2-pyrrolidone or acetone. However, in a case in which the organic solvent is used, since most of the organic solvent is highly volatile, explosion may occur, and manufacturing cost of the battery may be increased due to the relatively expensive organic solvent.

However, in the present invention, since the water may be used as the solvent by using a water-based binder system, in which the styrene-butadiene rubber is dispersed together with the carboxymethyl cellulose as a thickener, during the preparation of a negative electrode, price competitiveness of the battery may be improved and process safety may be enhanced.

Examples of a mixing means of step 1a may be mixing devices such as a ball mill, a sand mill, a bead mill, a roll mill, a pigment disperser, a meat mill, an ultrasonic disperser, a homogenizer, a homomixer, and a planetary mixer. Specifically, it is desirable for the mixing to be performed for 30 minutes or more with the homomixer in terms of increasing dispersibility of the styrene-butadiene rubber.

In the method of preparing the first negative electrode slurry according to the present invention, step 1b is a step of mixing the first mixed solution with a silicon-based active material to prepare a first negative electrode slurry.

The styrene-butadiene rubber as well as the carboxymethyl cellulose is included in the first mixed solution. Thus, in a case in which the silicon-based active material is added to the first mixed solution, the probability of distribution of the styrene-butadiene rubber, as a binder, on the surface of the silicon-based active material is increased. Eventually, since the number of effective contact surfaces between the silicon-based active material and the styrene-butadiene rubber is increased, the severe volume change of the silicon-based active material may be suppressed even during the charge and discharge, and the extraction of the silicon-based active material from the electrode may be prevented due to the strong adhesion.

In this case, examples of a mixing means of step 1b may be mixing devices such as a ball mill, a sand mill, a bead mill, a roll mill, a pigment disperser, a meat mill, an ultrasonic disperser, a homogenizer, a homomixer, and a planetary mixer, and, specifically, it is desirable for the mixing to be performed for 40 minutes or more with the planetary mixer in terms of increasing dispersibility of the particles.

The second negative electrode slurry according to an embodiment of the present invention may include a graphite-based active material.

As the graphite-based active material, at least one selected from the group consisting of amorphous carbons, which are prepared by heat treating a raw material, such as a coal tar pitch, a petroleum-based pitch, and various organic materials, or crystalline carbons, such as natural graphite having a high degree of graphitization, artificial graphite, carbon black, mesocarbon microbeads, and carbon fibers, may be used.

Specifically, natural graphite and artificial graphite may be used together. In a case in which the natural graphite among the above materials is used, the adhesion of the electrode may be improved, and, in a case in which the artificial graphite is used, a swelling phenomenon of the electrode may be reduced and output characteristics may be improved.

An average particle diameter (D50 of the graphite-based active material may be in a range of 10 μm to 30 μm. In a case in which the average particle diameter of the graphite-based active material is greater than 30 μm, dispersion may not occur properly in the second negative electrode slurry, and processability may be reduced when the current collector is coated with the slurry.

In the present invention, the average particle diameter of the particles may be defined as a particle diameter at 50% in a cumulative particle diameter distribution. For example, the average particle diameter (D50 of the particles according to an embodiment of the present invention may be measured by using a laser diffraction method. The laser diffraction method may generally measure a particle diameter ranging from a submicron level to a few mm, and may obtain highly repeatable and high resolution results.

The second negative electrode slurry according to the embodiment of the present invention may include a conductive agent. Since the second negative electrode slurry includes the conductive agent, movement of electrons between the negative electrode active material particles may be facilitated, and, accordingly, the output characteristics may be improved. In particular, since the conductive agent may be better distributed on a surface of the graphite-based active material by being included in the second negative electrode slurry, the output characteristics of the negative electrode may be further improved.

The conductive agent is not particularly limited as long as it has conductivity without causing adverse chemical changes in the battery, and, conductive materials, for example, graphite such as natural graphite and artificial graphite; carbon black such as acetylene black, Ketjen black, channel black, furnace black, lamp black, and thermal black; conductive fibers such as carbon fibers or metal fibers; conductive tubes such as carbon nanotubes; metal powder such as fluorocarbon powder, aluminum powder, and nickel powder;

conductive whiskers such as zinc oxide whiskers and potassium titanate whiskers; conductive metal oxide such as titanium oxide; or polyphenylene derivatives, may be used.

An average particle diameter (D50) of the conductive agent may be in a range of 10 nm to 40 nm.

The second negative electrode slurry according to the embodiment of the present invention may include a styrene-butadiene rubber. The styrene-butadiene rubber may be included as a binder and may provide adhesion between a current collector and the negative electrode active material or the negative electrode active material particles. The binder may not only be composed of the styrene-butadiene rubber, but may also further include an acryl-based binder, acrylic acid, acrylonitrile, an isoprene polymer in addition to the styrene-butadiene rubber. During the preparation of the second negative electrode slurry, the above materials may be added as binder materials in addition to the styrene-butadiene rubber.

The second negative electrode slurry according to the embodiment of the present invention may include a carboxymethyl cellulose. The carboxymethyl cellulose may be included as a thickener, and the thickener may improve coating properties and fluidity of the negative electrode slurry including the second negative electrode slurry.

The graphite-based active material, the carboxymethyl cellulose, the styrene-butadiene rubber, and the conductive agent in the second negative electrode slurry according to the embodiment of the present invention may be included in a weight ratio of 91:3.0:3.0:3.0 to 98.5:0.5:0.5:0.5.

In a case in which the conductive agent is included in an amount less than 0.5 part by weight based on a total weight of the second negative electrode slurry, the resistance in the electrode may be increased due to the excessive amount of the thickener and electrode output characteristics may be degraded. In a case in which the conductive agent is included in an amount greater than 3.0 parts by weight based on the total weight of the second negative electrode slurry, dispersion of the conductive agent may not be facilitated.

In the method of preparing a negative electrode slurry according to the embodiment of the present invention, a method of preparing the second negative electrode slurry may include the steps of: preparing a second mixed solution by mixing a carboxymethyl cellulose and a conductive agent with a solvent (step 1c); mixing the second mixed solution with a graphite-based active material (step 1d); and mixing a styrene-butadiene rubber with the second mixed solution in which the graphite-based active material is mixed (step 1e).

Hereinafter, the method of preparing the second negative electrode slurry according to the present invention will be described in detail for each step.

In the method of preparing the second negative electrode slurry according to the present invention, step 1c is a step of preparing a second mixed solution by mixing a carboxymethyl cellulose and a conductive agent with a solvent.

Water may be used as the solvent. In a case in which a conventional binder, such as polyvinylidene fluoride (PVDF), is used, a non-aqueous system is mainly used in which the polyvinylidene fluoride is dissolved in an organic solvent such as N-methyl-2-pyrrolidone or acetone. However, in a case in which the organic solvent is used, since most of the organic solvent is highly volatile, explosion may occur, and the manufacturing cost of the battery may be increased due to the relatively expensive organic solvent.

However, in the present invention, since the water may be used as the solvent by using a water-based binder system, in which the styrene-butadiene rubber is dispersed together with the carboxymethyl cellulose as a thickener, during the preparation of the negative electrode, the price competitiveness of the battery may be improved and the process safety may be enhanced.

Examples of a mixing means of step 1c may be mixing devices such as a ball mill, a sand mill, a bead mill, a roll mill, a pigment disperser, a meat mill, an ultrasonic disperser, a homogenizer, a homomixer, and a planetary mixer. Specifically, it is desirable for the mixing to be performed for 20 minutes or more with the homomixer in terms of increasing dispersibility of the conductive agent.

In the method of preparing the second negative electrode slurry according to the present invention, step 1d is a step of mixing the second mixed solution with a graphite-based active material.

The conductive agent as well as the carboxymethyl cellulose is uniformly dispersed in the second mixed solution.

Thus, a second negative electrode slurry may be prepared in which the carboxymethyl cellulose and the conductive agent are uniformly distributed on the surface of the graphite-based active material.

Examples of a mixing means of step 1d may be mixing devices such as a ball mill, a sand mill, a bead mill, a roll mill, a pigment disperser, a meat mill, an ultrasonic disperser, a homogenizer, a homomixer, and a planetary mixer, and, specifically, it is desirable for the mixing to be performed for 40 minutes or more with the planetary mixer in terms of increasing dispersibility of the active material.

In the method of preparing the second negative electrode slurry according to the present invention, step 1e is a step of mixing a styrene-butadiene rubber with the second mixed solution in which the graphite-based active material is mixed.

Adhesion between the graphite-based active material particles may be enhanced by mixing the styrene-butadiene rubber.

Examples of a mixing means of step 1e may be mixing devices such as a ball mill, a sand mill, a bead mill, a roll mill, a pigment disperser, a meat mill, an ultrasonic disperser, a homogenizer, a homomixer, and a planetary mixer, and, specifically, it is desirable for the mixing to be performed for 20 minutes or more with the homomixer in terms of increasing dispersibility of the styrene-butadiene rubber.

In the method of preparing a negative electrode slurry according to the present invention, step 2 is a step of mixing the first negative electrode slurry and the second negative electrode slurry which are prepared in step 1.

A conventional method of preparing a negative electrode slurry using both graphite-based active material and silicon-based active material as a negative electrode active material proceeds in sequence of adding a styrene-butadiene rubber after a carboxymethyl cellulose, a conductive agent, and an active material are first mixed.

However, in the present invention, in order to preferentially locate the styrene-butadiene rubber on the surface of the silicon-based active material, the first negative electrode slurry, in which the silicon-based active material and the styrene-butadiene rubber are mixed, and the second negative electrode slurry, in which the graphite-based active material, the conductive agent, and the styrene-butadiene rubber are mixed, are prepared separately.

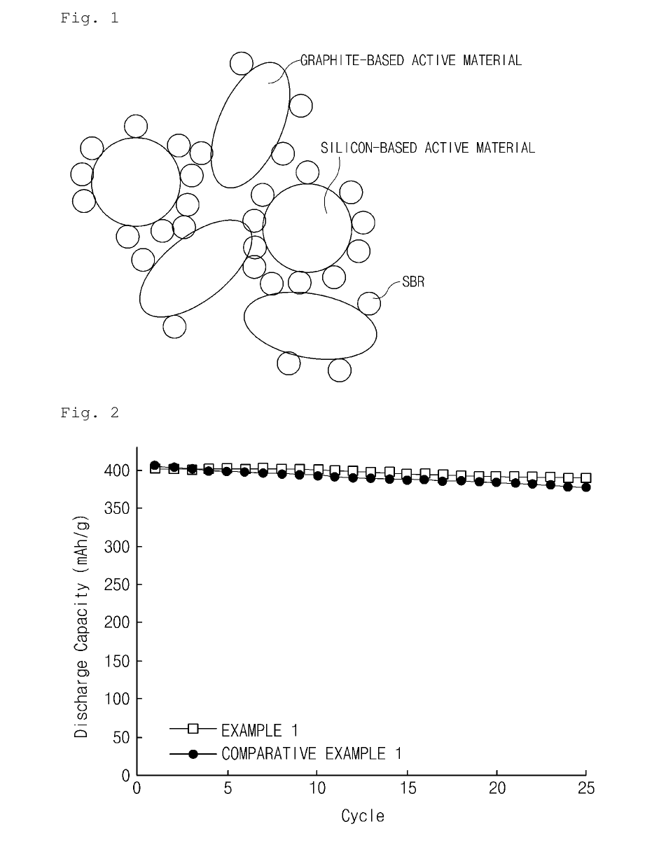

Since the styrene-butadiene rubber may be distributed on the surface of the silicon-based active material in the first negative electrode slurry preferentially mixed and the styrene-butadiene rubber is still distributed on the surface of the silicon-based active material even if the first negative electrode slurry and the second negative electrode slurry are mixed as in step 2, the styrene-butadiene rubber may be distributed on the surface of the silicon-based active material in the negative electrode prepared by using the above negative electrode slurry as describe in FIG. 1. Thus, since the severe volume change occurred during the charge and discharge of the silicon-based active material is suppressed and the extraction of the silicon-based active material from the electrode is prevented, the negative electrode may exhibit excellent life characteristics.

Examples of a mixing means of step 2 may be mixing devices such as a ball mill, a sand mill, a bead mill, a roll mill, a pigment disperser, a meat mill, an ultrasonic disperser, a homogenizer, a homomixer, and a planetary mixer, and, specifically, it is desirable for the mixing to be performed for 30 minutes or more with the homomixer in terms of further improving dispersibility of the slurry.

In the method of preparing a negative electrode slurry according to the embodiment of the present invention, a weight ratio of the silicon-based active material to the graphite-based active material may be in a range of 1:9 to 3:7.

In a case in which the silicon-based active material is included in an amount greater than 30 wt %, that is, the graphite-based active material is included in an amount less than 70 wt %, based on a weight of the total active materials, the life characteristics may be degraded due to the volume expansion of the silicon-based active material.

In the method of preparing a negative electrode slurry according to the embodiment of the present invention, a weight ratio of the carboxymethyl cellulose in the first negative electrode slurry to the carboxymethyl cellulose in the second negative electrode slurry may be in a range of 0.5:9.5 to 5:5.

The carboxymethyl cellulose may play a role in adjusting viscosity in each slurry and allowing solid contents, such as the active materials, the styrene-butadiene rubber, and the conductive agent, to be uniformly dispersed. Thus, an amount of each carboxymethyl cellulose may vary in proportion to the weight ratio of the silicon-based active material and the graphite-based active material which are respectively included in the first negative electrode slurry and the second negative electrode slurry.

For example, in a case in which the silicon-based active material and the graphite-based active material are respectively included in the negative electrode slurry in an amount of 10 wt % and 90 wt % based on the weight of the total active materials in the negative electrode slurry, a weight percent of the carboxymethyl cellulose in the first negative electrode slurry including the silicon-based active material may be 10 wt % and a weight percent of the carboxymethyl cellulose in the second negative electrode slurry including the graphite-based active material may be 90 wt % based on a weight of the total carboxymethyl cellulose in the negative electrode slurry.

In a case in which the weight percent of the carboxymethyl cellulose in the first negative electrode slurry is less than 0.5 wt % based on the weight of the total carboxymethyl cellulose in the negative electrode slurry, dispersion of the silicon-based active material and the styrene-butadiene rubber in the first negative electrode slurry may be difficult.

Also, in a case in which the weight percent of the carboxymethyl cellulose in the first negative electrode slurry is greater than 50 wt %, that is, the weight percent of the carboxymethyl cellulose in the second negative electrode slurry is less than 50 wt %, based on the weight of the total carboxymethyl cellulose in the negative electrode slurry, dispersion of the graphite-based active material and the conductive agent in the second negative electrode slurry may be difficult.

A method of preparing a negative electrode according to an embodiment of the present invention includes the steps of: coating a current collector with a negative electrode slurry prepared by the method of preparing a negative electrode slurry (step 3); and drying and rolling the negative electrode slurry coated on the current collector of step 3 (step 4).

Hereinafter, the method of preparing a negative electrode according to the present invention will be described in detail for each step.

In the method of preparing a negative electrode according to the embodiment of the present invention, step 3 is a step of coating a current collector with a negative electrode slurry prepared by the method of preparing a negative electrode slurry.

The current collector is not particularly limited as long as it has conductivity without causing adverse chemical changes in the battery, and, for example, copper, stainless steel, aluminum, nickel, titanium, fired carbon, or aluminum or stainless steel that is surface-treated with one of carbon, nickel, titanium, silver, or the like may be used.

The current collector is prepared, and a layer of the negative electrode slurry of the present invention is then formed on the current collector. In this case, typically, the layer of the negative electrode slurry is formed by coating the current collector with the negative electrode slurry of the present invention. Also, the negative electrode slurry may be coated on one side of the current collector or may be coated on both sides thereof.

A method of the coating is not particularly limited, but, for example, may include a method such as a doctor blade method, a dip method, a reverse roll method, a direct roll method, a gravure method, an extrusion method, and a brush coating method.

Furthermore, a thickness of the layer of the negative electrode slurry may be appropriately set according to a desired thickness of a negative electrode active material layer.

In the method of preparing a negative electrode according to the embodiment of the present invention, step 4 is a step of drying and rolling the negative electrode slurry coated on the current collector of step 3.

The drying is a process of removing the solvent in the slurry to dry the negative electrode slurry coated on the current collector. Examples of a drying method may be drying with wind such as warm wind, hot wind, and low moisture wind; vacuum drying; and a drying method by irradiation of an energy ray such as infrared ray, far infrared ray, and electron beam. As a specific example, drying may be performed within one day in a vacuum oven at a temperature of 50° C. to 200° C.

The rolling is a process of increasing capacity density of the electrode and increasing adhesiveness between the current collector and the active materials. As a rolling method, a pressing treatment may be performed on the negative electrode active material layer by using a die press or a roll press.

A negative electrode according to an embodiment of the present invention may be prepared by the method of preparing a negative electrode.

Since the styrene-butadiene rubber is distributed on the surface of the silicon-based active material in the negative electrode, the volume change of the silicon-based active material during the charge and discharge may be prevented, and, accordingly, the extraction of the silicon-based active material from the negative electrode may be prevented. Thus, the negative electrode may exhibit excellent life characteristics while having high capacity.

A secondary battery according to an embodiment of the present invention may include the negative electrode prepared by the method of preparing a negative electrode, a positive electrode, a separator disposed between the negative electrode and the positive electrode, and an electrolyte.

Since the secondary battery includes the negative electrode, the secondary battery may exhibit excellent life characteristics while having high capacity.

After a positive electrode collector is coated with a slurry which is prepared by mixing a positive electrode material mixture including positive electrode active material particles, a conductive agent, and a binder with a solvent, the positive electrode may be prepared by drying and rolling the coated positive electrode collector.

The collector is not particularly limited as long as it has conductivity without causing adverse chemical changes in the battery, and, for example, copper, stainless steel, aluminum, nickel, titanium, fired carbon, or aluminum or stainless steel that is surface-treated with one of carbon, nickel, titanium, silver, or the like may be used.

Examples of the positive electrode active material may be a layered compound, such as lithium cobalt oxide (LiCoO₂) or lithium nickel oxide (LiNiO₂), or a compound substituted with one or more transition metals; lithium manganese oxides such as Li_{1+y1}Mn_{2-y1}O₄ (0≦y1≦0.33), LiMnO₃, LiMn₂O₃, and LiMnO₂; lithium copper oxide (Li₂CuO₂); vanadium oxides such as LiV₃O₈, V₂O₅, and Cu₂V₂O₇; nickel (Ni)-site type lithium nickel oxide expressed by a chemical formula of LiNi_{1-y2}M_{y2}O₂ (where M is cobalt (Co), manganese (Mn), aluminum (Al), copper (Cu), iron (Fe), magnesium (Mg), boron (B), or gallium (Ga), and y2 satisfies 0.01≦y2≦0.3); lithium manganese complex oxide expressed by a chemical formula of LiMn_{2-y3}M_{y3}O₂ (where M is Co, Ni, Fe, chromium (Cr), zinc (Zn), or tantalum (Ta), and y3 satisfies 0.01≦y3≦0.1) or Li₂Mn₃MO₈ (where M is Fe, Co, Ni, Cu, or Zn); and LiMn₂O₄ having a part of lithium (Li) being substituted with alkaline earth metal ions, but the positive electrode active material is not limited thereto.

Various types of binder polymers, such as a polyvinylidene fluoride-hexafluoropropylene copolymer (PVDF-co-HFP), polyvinylidene fluoride, polyacrylonitrile, polymethylmethacrylate, polyvinyl alcohol, carboxymethyl cellulose (CMC), starch, hydroxypropyl cellulose, regenerated cellulose, polyvinylpyrrolidone, tetrafluoroethylene, polyethylene, polypropylene, an ethylene-propylene-diene monomer (EPDM), a sulfonated EPDM, a styrene-butadiene rubber (SBR), a fluorine rubber, poly acrylic acid, and a polymer having hydrogen thereof substituted with Li, sodium (Na), and calcium (Ca), or various copolymers, may be used as the binder.

The conductive agent is not particularly limited as long as it has conductivity without causing adverse chemical changes in the battery, and, conductive materials, for example, graphite such as natural graphite and artificial graphite; carbon black such as acetylene black, Ketjen black, channel black, furnace black, lamp black, and thermal black; conductive fibers such as carbon fibers or metal fibers; conductive tubes such as carbon nanotubes; metal powder such as fluorocarbon powder, aluminum powder, and nickel powder; conductive whiskers such as zinc oxide whiskers and potassium titanate whiskers; conductive metal oxide such as titanium oxide; or polyphenylene derivatives, may be used.

The solvent may be a solvent typically used in the art. The solvent may include dimethyl sulfoxide (DMSO), isopropyl alcohol, N-methylpyrrolidone (NMP), acetone, or water, and any one thereof or a mixture of two or more thereof may be used.

The separator separates the negative electrode and the positive electrode and provides a movement path of lithium ions, wherein any separator may be used as the separator without particular limitation as long as it is typically used in a secondary battery, and particularly, a separator having high moisture-retention ability for an electrolyte as well as low resistance to the transfer of electrolyte ions may be used. Specifically, a porous polymer film, for example, a porous polymer film prepared from a polyolefin-based polymer, such as an ethylene homopolymer, a propylene homopolymer, an ethylene/butene copolymer, an ethylene/hexene copolymer, and an ethylene/methacrylate copolymer, or a laminated structure having two or more layers thereof may be used. Also, a typical porous nonwoven fabric, for example, a nonwoven fabric formed of high melting point glass fibers or polyethylene terephthalate fibers may be used. Furthermore, a coated separator including a ceramic component or a polymer component may be used to secure heat resistance or mechanical strength, and the separator having a single layer or multilayer structure may be selectively used.

The electrolyte may include an organic liquid electrolyte, an inorganic liquid electrolyte, a solid polymer electrolyte, a gel-type polymer electrolyte, a solid inorganic electrolyte, or a molten-type inorganic electrolyte which may be used in the preparation of the lithium secondary battery, but the present invention is not limited thereto.

Specifically, the electrolyte may include a non-aqueous organic solvent and a metal salt.

Examples of the non-aqueous organic solvent may be aprotic organic solvents, such as N-methyl-2-pyrrolidone, propylene carbonate, ethylene carbonate, butylene carbonate, dimethyl carbonate, diethyl carbonate, γ-butyrolactone, 1,2-dimethoxy ethane, tetrahydroxy franc, 2-methyl tetrahydrofuran, dimethyl sulfoxide, 1,3-dioxolane, formamide, diemthylformamide, dioxolane, acetonitrile, nitromethane, methyl formate, methyl acetate, phosphate triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, and ethyl propionate.

In particular, ethylene carbonate and propylene carbonate, ring-type carbonates among the carbonate-based organic solvents, well dissociate a lithium salt in the electrolyte solution due to high dielectric constants as high-viscosity organic solvents, and thus, the ring-type carbonate may be used. Since an electrolyte solution having high electrical conductivity may be prepared when the ring-type carbonate is mixed with low-viscosity, low-dielectric constant linear carbonate, such as dimethyl carbonate and diethyl carbonate, in an appropriate ratio, the ring-type carbonate, for example, may be used.

A lithium salt may be used as the metal salt, and the lithium salt is a material that is readily soluble in the non-aqueous electrolyte solution, wherein, for example, any one selected from the group consisting of F⁻, Cl⁻, I⁻, NO₃⁻, N(CN)₂⁻, BF₄⁻, CO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCN⁻, and (CF₃CF₂SO₂)₂N⁻ may be used as an anion of the lithium salt.

At least one additive, for example, a haloalkylene carbonate-based compound such as difluoroethylene carbonate, pyridine, triethylphosphite, triethanolamine, cyclic ether, ethylenediamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, may be further included in the electrolyte in addition to the above-described electrolyte components for the purpose of improving the life characteristics of the battery, preventing a decrease in battery capacity, and improving discharge capacity of the battery.

The secondary battery is suitable for portable devices, such as mobile phones, notebook computers, and digital cameras, and electric cars such as a hybrid electric vehicle (HEV).

According to another embodiment of the present invention, a battery module including the secondary battery as a unit cell and a battery pack including the battery module are provided. The battery module or the battery pack may be used as a power source of any one of medium and large sized devices, for example, a power tool; electric cars including an electric vehicle (EV), a hybrid electric vehicle, and a plug-in hybrid electric vehicle (PHEV); or a power storage system.

Hereinafter, exemplary embodiments will be described in detail to fully explain the present invention in such a manner that it may easily be carried out by a person with ordinary skill in the art to which the present invention pertains. However, the present invention may be modified in various forms and is not limited to the disclosed embodiments.

### Example 1

Preparation of Negative Electrode

Step 1: Preparation of First Negative Electrode Slurry and Preparation of Second Negative Electrode Slurry

Preparation of First Negative Electrode Slurry

1 wt % of an aqueous solution including a carboxymethyl cellulose having a weight-average molecular weight of 800,000 and a styrene-butadiene rubber having an average particle diameter of 200 nm were mixed with a homomixer. Thereafter, the carboxymethyl cellulose and the styrene-butadiene rubber were mixed with SiO having an average particle diameter of 10 μm in a ratio of 1:1:98 for 40 minutes by using a planetary mixer to prepare a first negative electrode slurry.

Preparation of Second Negative Electrode Slurry

1 wt % of an aqueous solution including a carboxymethyl cellulose having a weight-average molecular weight of 800,000 and a conductive agent having an average particle diameter of 10 nm were mixed with a homomixer to prepare a second mixed solution.

Artificial graphite having an average particle diameter (D50) of 20 μm and natural graphite were added as a graphite-based active material to the second mixed solution, and mixed with a planetary mixer for 40 minutes. Thereafter, the same styrene-butadiene rubber as that used in the first negative electrode slurry was added to the second mixed solution to prepare a second negative electrode slurry. A weight ratio of the active material:the conductive agent:the carboxymethyl cellulose:the styrene-butadiene rubber was 95:1:2:2.

In this case, a weight ratio of the SiO to the graphite-based active material was 1:9, and a weight ratio of the carboxymethyl cellulose in the first negative electrode slurry to the carboxymethyl cellulose in the second negative electrode slurry was 1:9. A weight ratio of the styrene-butadiene rubber in the first negative electrode slurry to the styrene-butadiene rubber in the second negative electrode slurry was 1:9.

Step 2: Mixing of First Negative Electrode Slurry and Second Negative Electrode Slurry

The first negative electrode slurry and the second negative electrode slurry were mixed with a homomixer for 30 minutes to prepare a negative electrode slurry.

Step 3: Preparation of Negative Electrode

After a 20 μm thick copper thin film of a negative electrode collector was coated with the negative electrode slurry prepared in step 2 to a thickness of 100 μm and dried for 3 hours in a vacuum oven at 100° C., the dried collector was rolled between rolls heated to 100° C. at a pressure of 15 MPa to prepare a negative electrode having a final thickness (collector+active material layer) of 120 μm.

Preparation of Positive Electrode

A slurry was prepared by mixing lithium cobalt composite oxide as a positive electrode active material, carbon black as a conductive agent, and a polyvinylidene fluoride (PVDF), as a binder, in a weight ratio of 96:2:2, and an aluminum foil, as a positive electrode collector, was then coated with the slurry and dried for 3 hours in a vacuum oven at 120° C. to prepare a positive electrode having a thickness of 130 μm.

Preparation of Secondary Battery

The above-prepared positive electrode and negative electrode, and a porous polyethylene separator were assembled by using a stacking method, and an electrolyte solution (ethylene carbonate (EC)/ethyl methyl carbonate (EMC)=1/2 (volume ratio)) and lithium hexafluorophosphate (1 M LiPF₆) were injected into the assembled battery to prepare a lithium secondary battery.

### Comparative Example 1

A secondary battery was prepared in the same manner as in Example 1 except that the following negative electrode slurry was used instead of the negative electrode slurry prepared in steps 1 and 2 of Example 1.

Preparation of Negative Electrode Slurry

SiO having an average particle diameter (D50) of 10 μm, artificial graphite having an average particle diameter (D₅₀) of 20 μm, and natural graphite were mixed in a weight ratio of 10:30:60 to prepare a negative electrode active material.

1 wt % of a carboxymethyl cellulose solution and a conductive agent were mixed with a homomixer for 20 minutes. The negative electrode active material was added to the mixed solution and mixed with a planetary mixer for 40 minutes.

A dispersed styrene-butadiene rubber solution (concentration 40 wt %) was added to the mixed solution to which the negative electrode active material was added, and mixed with a homomixer for 30 minutes to prepare a negative electrode slurry.

### <Experimental Example 1> Adhesion Measurement

In order to investigate adhesive strength of the negative electrodes prepared in Example 1 and Comparative Example 1, a 180° peeling test was performed on the samples with a width of 50 mm at a speed of 300 mm/min, and the results thereof are presented in Table 1.

TABLE 1

| | Adhesion (gf) |
|---|---|
| Example 1 | 41.5 |
| Comparative Example 1 | 39.5 |

### <Experimental Example 2> Life Characteristics

The following experiment was performed to investigate life characteristics of the secondary batteries prepared in Example 1 and Comparative Example 1.

The life characteristics of each lithium secondary battery were measured by performing charge and discharge at 0.1 C in a first cycle and performing charge and discharge at 0.5 C in subsequent cycles. A ratio of discharge capacity in a 25th cycle to the first cycle discharge capacity was measured.

The following Table 2 and FIG. 2 illustrate the life characteristics of the secondary batteries prepared in Example 1 and Comparative Example 1.

TABLE 2

| | Life characteristics (%) |
|---|---|
| Example 1 | 96.7 |
| Comparative Example 1 | 92.8 |

Life characteristics: (discharge capacity in a 25th cycle/first cycle discharge capacity)×100

Although the exemplary embodiments of the present invention have been described in detail, the scope of the present invention is not limited thereto but various modifications and improvements made by those skilled in the art using the basic concept of the present invention defined in the claims also fall within the scope of the present invention.

1. A method of preparing a negative electrode slurry, the method comprising steps of:
preparing a first negative electrode slurry including a silicon-based active material, a carboxymethyl cellulose, and a styrene-butadiene rubber, and a second negative electrode slurry including a graphite-based active material, a conductive agent, a styrene-butadiene rubber, and a carboxymethyl cellulose (step 1); and
mixing the first negative electrode slurry and the second negative electrode slurry which are prepared in step 1 (step 2).

2. The method of claim 1, wherein a weight ratio of the carboxymethyl cellulose in the first negative electrode slurry to the carboxymethyl cellulose in the second negative electrode slurry is in a range of 0.5:9.5 to 5:5.

3. The method of claim 1, wherein a weight ratio of the silicon-based active material to the graphite-based active material is in a range of 1:9 to 3:7.

4. The method of claim 1, wherein the preparing of the first negative electrode slurry comprises steps of:
preparing a first mixed solution by mixing the carboxymethyl cellulose and the styrene-butadiene rubber with a solvent (step 1a); and
mixing the first mixed solution with the silicon-based active material to prepare the first negative electrode slurry (step 1b).

5. The method of claim 1, wherein the preparing of the second negative electrode slurry comprises steps of:
preparing a second mixed solution by mixing the carboxymethyl cellulose and the conductive agent with a solvent (step 1c);
mixing the second mixed solution with the graphite-based active material (step 1d); and
mixing the styrene-butadiene rubber with the second mixed solution in which the graphite-based active material is mixed (step 1e).

6. The method of claim 1, wherein a weight ratio of the silicon-based active material:the carboxymethyl cellulose:the styrene-butadiene rubber in the first negative electrode slurry is in a range of 94:3.0:3.0 to 99:0.5:0.5.

7. The method of claim 1, wherein a weight ratio of the graphite-based active material the carboxymethyl cellulose:the styrene-butadiene rubber:the conductive agent in the second negative electrode slurry is in a range of 91:3.0:3.0:3.0 to 98.5:0.5:0.5:0.5.

8. The method of claim 1, wherein the silicon-based active material is SiO.

9. The method of claim 1, wherein the graphite-based active material comprises artificial graphite and natural graphite.

10. A negative electrode slurry prepared by the method of preparing a negative electrode slurry of claim 1.

11. A method of preparing a negative electrode, the method comprising steps of:
coating a current collector with the negative electrode slurry of claim 10 (step 3); and
drying and rolling the negative electrode slurry coated on the current collector of step 3 (step 4).

12. A negative electrode prepared by the method of preparing a negative electrode of claim 11.
